(19) United States
(12) Patent Application Publication
(10) Pub. No.: US 2024/0289772 A1
(43) Pub. Date: Aug. 29, 2024

(54) METHOD FOR PROVIDING COMMUNITY SERVICE BASED ON ELECTRONIC WALLET AND COMMUNITY SERVER USING THE SAME

(71) Applicant: Wemade Co., Ltd., Seongnam-si (KR)

(72) Inventor: Moheon SONG, Seoul (KR)

(73) Assignee: Wemade Co., Ltd., Seongnam-si (KR)

(21) Appl. No.: 18/413,226

(22) Filed: Jan. 16, 2024

(30) Foreign Application Priority Data
Feb. 24, 2023 (KR) 10-2023-0025101
Apr. 21, 2023 (KR) 10-2023-0052889

(51) Int. Cl. G06Q 20/36; G06Q 20/38

(52) U.S. Cl. CPC G06Q 20/3674; G06Q 20/3825; G06Q 20/3829

(57) ABSTRACT

There in provided a method for providing a community service to a user based on a user electronic wallet. The method includes steps of: verifying user signature requesting code, user signature value and user electronic wallet address; and if the user electronic wallet address and the user signature requesting code are valid, and (i) acquiring 1-st current state information of the user electronic wallet, (ii) updating previous accessible state information to 1-st current accessible state information for each of community channels by referring to the 1-st current state information and each of access conditions for each of the community channels and (iii) providing a user-specific community channel list including each of accessible user-specific community channels, among the community channels, which is determined by referring to the 1-st current accessible state information.

### CROSS REFERENCE OF RELATED APPLICATION

This present application claims the benefit of the earlier filing date of Korean provisional patent application No. 10-2023-0025101, filed on Feb. 24, 2023 and the earlier filing date of Korean non-provisional patent application No. 10-2023-0052889, filed on Apr. 21, 2023, the entire contents of which being incorporated herein by reference.

### FIELD OF THE DISCLOSURE

The present disclosure relates to a method for providing a community service based on an electronic wallet and a community server using the same.

### BACKGROUND OF THE DISCLOSURE

Conventional community services may request users to provide their electronic mail addresses, phone numbers or information on other social media accounts when the users try to join or log on to the conventional community services. For example, in case of a KakaoTalk service which provides various community services, authentication processes on the users are conducted at a main server which provides the KaKaoTalk service, and the users should provide their own IDs, passwords and other social login methods for the authentication processes. That is, according to the KakaoTalk service, processes of authenticating the users and processes of authorizing the users are performed by its own server and user data are stored in a central storage.

However, when some problems occur in the main server, there is a probability of personal information leakage.

Further, according to the conventional community services, hosts of community channels should manage their members by themselves. Therefore, it may be a problem for the hosts of the community channels to check whether each of the members meets each of access conditions for each of the community channels.

In addition, when the hosts of the community channels try to check whether each of the members meets each of access conditions for each of the community channels by using information on the members, there is probability of the personal information leakage related to the information on the members.

Further, there may be limitations for the hosts to check whether information on each of prospective members who has an intention to join each of the community channels meets each of the access conditions for each of the community channels.

Therefore, there may also be problem in that another user who is not related to one of the community channels may join it and post advertisements or topics not related to it, which may cause inconvenience to other qualified members.

### SUMMARY OF THE DISCLOSURE

It is an object of the present disclosure to solve all the aforementioned problems.

It is another object of the present disclosure to provide community services without exposing private information of users.

It is still another object of the present disclosure to reduce a difficulty of hosts of community channels in checking whether each of members meets each of access conditions for each of the community channels.

It is still yet another object of the present disclosure to reduce a difficulty of the users in checking whether the users themselves meet the access conditions without exposing the private information of the users.

It is still yet another object of the present disclosure to allow whether each of the members is matched with each of the access conditions for each of the community channels to be easily checked.

It is still yet another object of the present disclosure to easily match each of the members with each of topics corresponding to each of the community channels.

It is still yet another object of the present disclosure to prevent each of some users who is not related to each of the topics from joining each of the community channels.

In accordance with one example embodiment of the present disclosure, there is provided a method for providing a community service to a user based on a user electronic wallet, comprising steps of: (a) on condition that a user electronic wallet address which is acquired from a user electronic wallet application and a user signature requesting code which is provided to a user terminal have been registered in a database, in response to acquiring community service requesting information including the user electronic wallet address, the user signature requesting code and a user signature value from the user terminal, wherein the user signature value is acquired by signing the user signature requesting code with a user private key, a community server acquiring a user public key and checking whether the user signature requesting code, the user signature value and the user electronic wallet address are verified; and (b) in response to detecting that the user electronic wallet address, the user signature requesting code, and the user signature value received from the user terminal are verified, the community server checking whether the user electronic wallet address and the user signature requesting code are valid by using the database, and in response to detecting that the user electronic wallet address and the user signature requesting code are valid, the community server (i) acquiring 1-st current state information of the user electronic wallet by accessing the user electronic wallet using the user electronic wallet address, (ii) updating previous accessible state information for each of community channels to 1-st current accessible state information for each of the community channels by referring to the 1-st current state information and each of access conditions for each of the community channels and (iii) providing a user-specific community channel list including each of accessible user-specific community channels, among the community channels, which is determined by referring to the 1-st current accessible state information, to the user terminal.

As one example, before the step (a), the method further comprises steps of: (a01) in response to acquiring an electronic wallet connecting request from the user terminal, the community server supporting the user to allow the community server to access the user electronic wallet application; and (a02) in response to acquiring the user electronic wallet address from the user electronic wallet application after receiving a permission to access the user electronic wallet application from the user, the community server generating the user signature requesting code corresponding to the user electronic wallet address, storing the user signature requesting code and the user electronic wallet address in the database, and acquiring the user signature value from the user electronic wallet application; and (a03) the community server transmitting the user electronic wallet address, the user signature requesting code, and the user signature value to the user terminal or allowing the user electronic wallet application to transmit the user electronic wallet address, the user signature requesting code, and the user signature value to the user terminal.

As one example, the method further comprises a step of: (c) the community server, (i) acquiring 2-nd current state information every certain period of time by accessing the user electronic wallet using the user electronic wallet address, updating the 1-st current accessible state information for each of the community channels to 2-nd current accessible state information for each of the community channels by referring to the 2-nd current state information and each of the access conditions for each of the community channels, and providing the user-specific community channel list on each of the accessible user-specific community channels, among the community channels, which is determined by referring to the 2-nd current accessible state information, to the user terminal, or (ii) acquiring 3-rd current state information of the user electronic wallet by accessing the user electronic wallet using the user electronic wallet address in response to a synchronization request at a specific time from the user terminal, updating the 1-st current accessible state information for each of the community channels to 3-rd current accessible state information by referring to the 3-rd current state information and each of the access conditions for each of the community channels, and providing the user-specific community channel list on each of the accessible user-specific community channels, among the community channels, which is determined by referring to the 3-rd current accessible state information, to the user terminal.

As one example, in the method, in response to acquiring at least some part of information on kinds of one or more virtual currencies and balances of the virtual currencies stored in the user electronic wallet as the 1-st current state information of the user electronic wallet, the community server checks whether at least part of the kinds and the balances of the virtual currencies meets each of the access conditions for each of the community channels, thereby acquiring the 1-st current accessible state information.

As one example, during the method, in case the community server provides the user-specific community channel list which further includes each of inaccessible user-specific community channels to the user terminal, the community server sorts each of the inaccessible community channels and each of the accessible community channels by referring to the 1-st current accessible state information and then displays each of the sorted inaccessible community channels through a first region of a screen of the user terminal and each of the sorted accessible community channels through a second region of the screen of the user terminal.

As one example, The method further comprises a step of: (d) in response to acquiring a community accessing request for a certain inaccessible user-specific community channel in the user-specific community channel list from the user terminal, the community server providing at least one reason of not being able to access the certain inaccessible user-specific community channel to the user terminal by referring to a certain access condition of the certain inaccessible user-specific community channel and the 1-st current state information.

As one example, the method further comprises a step of: (e) (i) in response to acquiring a community channel searching request from the user terminal, the community server allowing the user to select at least one certain virtual currency in the user electronic wallet, and (ii) in response to acquiring information on the selected certain virtual currency, the community server checking whether each of the community channels is one of certain VC-related community channels corresponding to the certain virtual currency and then checking certain accessible state information for each of the certain VC-related community channels by referring to each of certain access conditions for each of the certain VC-related community channels and certain virtual currency state information for the certain virtual currency, and (iii) the community server providing a certain VC-related community channel list including the certain VC-related community channels each of which corresponds to the certain accessible state information to user terminal.

As one example, the method further comprises a step of: (f) (i) in response to acquiring a new community channel creating request from the user terminal, the community server requesting the user to select at least one certain virtual currency stored in the user electronic wallet, (ii) in response to acquiring information on the certain virtual currency from the user terminal, the community server requesting the user terminal to set a new access condition for a new community channel, and (iii) in response to acquiring information on the new access condition from the user terminal to create the new community channel, the community server allowing the new community channel to be exposed to search results.

As one example, at the step (a), the community server requests the blockchain network to verify the user electronic wallet address, the user signature requesting code, and the user signature value received from the user terminal.

As one example, at the step (a), wherein the community server (i) decodes the user signature value received from the user terminal by using the user public key and thus acquires the user signature requesting code, (ii) checks whether the user signature requesting code acquired by decoding the user signature value is coincident with the user signature requesting code received from the user terminal and thus checks whether the user signature requesting code and the user signature value received from the user terminal are verified, and (iii) checks whether the user electronic wallet address acquired from the user terminal is registered as a valid address in the blockchain network and thus verifies whether the user electronic wallet address acquired from the user terminal is valid; and wherein, at the step (b), the community server checks whether the user electronic wallet address and the user signature requesting code received from the user terminal are coincident with the user electronic wallet address and the user signature requesting code stored in the database and thus verifies whether the user electronic wallet address and the user signature requesting code received from the user terminal are valid.

In accordance with another aspect of the present disclosure, there is provided a community server for providing a community service to a user based on a user electronic wallet, comprising: at least one memory which stores instructions; and at least one processor configured to execute the instructions to perform or support another device to perform processes of: (I) on condition that a user electronic wallet address which is acquired from a user electronic wallet application and a user signature requesting code which is provided to a user terminal have been registered in a database, in response to acquiring community service requesting information including the user electronic wallet address, the user signature requesting code and a user signature value from the user terminal, wherein the user signature value is acquired by signing the user signature requesting code with a user private key, acquiring a user public key and checking whether the user signature requesting code, the user signature value and the user electronic wallet address are verified; and (II) in response to detecting that the user electronic wallet address, the user signature requesting code, and the user signature value received from the user terminal are verified, checking whether the user electronic wallet address and the user signature requesting code are valid by using the database, and in response to detecting that the user electronic wallet address and the user signature requesting code are valid, (i) acquiring 1-st current state information of the user electronic wallet by accessing the user electronic wallet using the user electronic wallet address, (ii) updating previous accessible state information for each of community channels to 1-st current accessible state information for each of the community channels by referring to the 1-st current state information and each of access conditions for each of the community channels and (iii) providing a user-specific community channel list including each of accessible user-specific community channels, among the community channels, which is determined by referring to the 1-st current accessible state information, to the user terminal.

As one example, before the process (I), the processor further performs processes of: (I_01) in response to acquiring an electronic wallet connecting request from the user terminal, supporting the user to allow the community server to access the user electronic wallet application; and (I_02) in response to acquiring the user electronic wallet address from the user electronic wallet application after receiving a permission to access the user electronic wallet application from the user, generating the user signature requesting code corresponding to the user electronic wallet address, storing the user signature requesting code and the user electronic wallet address in the database, and acquiring the user signature value from the user electronic wallet application; and (I_03) transmitting the user electronic wallet address, the user signature requesting code, and the user signature value to the user terminal or allowing the user electronic wallet application to transmit the user electronic wallet address, the user signature requesting code, and the user signature value to the user terminal.

As one example, the processor further performs a process of: (III) (i) acquiring 2-nd current state information every certain period of time by accessing the user electronic wallet using the user electronic wallet address, updating the 1-st current accessible state information for each of the community channels to 2-nd current accessible state information for each of the community channels by referring to the 2-nd current state information and each of the access conditions for each of the community channels, and providing the user-specific community channel list on each of the accessible user-specific community channels, among the community channels, which is determined by referring to the 2-nd current accessible state information, to the user terminal, or (ii) acquiring 3-rd current state information of the user electronic wallet by accessing the user electronic wallet using the user electronic wallet address in response to a synchronization request at a specific time from the user terminal, updating the 1-st current accessible state information for each of the community channels to 3-rd current accessible state information by referring to the 3-rd current state information and each of the access conditions for each of the community channels, and providing the user-specific community channel list on each of the accessible user-specific community channels, among the community channels, which is determined by referring to the 3-rd current accessible state information, to the user terminal.

As one example, during the process, in response to acquiring at least some part of information on kinds of one or more virtual currencies and balances of the virtual currencies stored in the user electronic wallet as the 1-st current state information of the user electronic wallet, the processor checks whether at least part of the kinds and the balances of the virtual currencies meets each of the access conditions for each of the community channels, thereby acquiring the 1-st current accessible state information.

As one example, during the process, in case the community server provides the user-specific community channel list which further includes each of inaccessible user-specific community channels to the user terminal, the processor sorts each of the inaccessible community channels and each of the accessible community channels by referring to the 1-st current accessible state information and then displays each of the sorted inaccessible community channels through a first region of a screen of the user terminal and each of the sorted accessible community channels through a second region of the screen of the user terminal.

As one example, the processor further performs a process of: (IV) in response to acquiring a community accessing request for a certain inaccessible user-specific community channel in the user-specific community channel list from the user terminal, providing at least one reason of not being able to access the certain inaccessible user-specific community channel to the user terminal by referring to a certain access condition of the certain inaccessible user-specific community channel and the 1-st current state information.

As one example, the processor further performs a process of: (V) (i) in response to acquiring a community channel searching request from the user terminal, allowing the user to select at least one certain virtual currency in the user electronic wallet, and (ii) in response to acquiring information on the selected certain virtual currency, checking whether each of the community channels is one of certain VC-related community channels corresponding to the certain virtual currency and then checking certain accessible state information for each of the certain VC-related community channels by referring to each of certain access conditions for each of the certain VC-related community channels and certain virtual currency state information for the certain virtual currency, and (iii) providing a certain VC-related community channel list including the certain VC-related community channels each of which corresponds to the certain accessible state information to user terminal.

As one example, the processor further performs a process of: (VI) (i) in response to acquiring a new community channel creating request from the user terminal, the community server requesting the user to select at least one certain virtual currency stored in the user electronic wallet, (ii) in response to acquiring information on the certain virtual currency from the user terminal, requesting the user terminal to set a new access condition for a new community channel, and (iii) in response to acquiring information on the new access condition from the user terminal to create the new community channel, allowing the new community channel to be exposed to search results.

As one example, at the process (I), the processor requests the blockchain network to verify the user electronic wallet address, the user signature requesting code, and the user signature value received from the user terminal.

As one example, at the process (I), the processor (i) decodes the user signature value received from the user terminal by using the user public key and thus acquires the user signature requesting code, (ii) checks whether the user signature requesting code acquired by decoding the user signature value is coincident with the user signature requesting code received from the user terminal and thus checks whether the user signature requesting code and the user signature value received from the user terminal are verified, and (iii) checks whether the user electronic wallet address acquired from the user terminal is registered as a valid address in the blockchain network and thus verifies whether the user electronic wallet address acquired from the user terminal is valid; and wherein, at the process (II), the processor checks whether the user electronic wallet address and the user signature requesting code received from the user terminal are coincident with the user electronic wallet address and the user signature requesting code stored in the database and thus verifies whether the user electronic wallet address and the user signature requesting code received from the user terminal are valid.

### BRIEF DESCRIPTION OF THE DRAWINGS

The accompanying drawings used to explain example embodiments of the present disclosure are only part of example embodiments of the present disclosure and other drawings can be obtained based on the accompanying drawings by those skilled in the art of the present disclosure without inventive work.

FIG. 1 is a drawing schematically illustrating a configuration of a community server which provides community services based on an electronic wallet.

FIG. 2 is a drawing schematically illustrating a process of supporting a user to allow the community server to access a user electronic wallet application in response to an electronic wallet connecting request from a user terminal.

FIG. 3 is a drawing schematically illustrating a method of providing the community services based on the electronic wallet in response to receiving community service requesting information from the user terminal.

FIG. 4A and FIG. 4B are drawings schematically illustrating a user interface for providing information on the community services to the user through the user terminal.

FIG. 5A is a drawing schematically illustrating a state of a screen provided as a result of selecting an inaccessible community channel among the community channels included in a user-specific community channel list.

FIG. 5B is a drawing schematically illustrating a state of the screen provided as a result of selecting an accessible community channel among the community channels included in the user-specific community channel list.

FIG. 5C is a drawing schematically illustrating a state of the screen provided as a result of selecting a new accessible community channel among the community channels included in the user-specific community channel list.

FIG. 6A is a drawing schematically illustrating an example of a list of user electronic wallets for allowing the user to select at least one of the user electronic wallets with which the user searches for one or more desired community channels.

FIG. 6B is a drawing schematically illustrating an example of some community channels retrieved as a result of a community channel searching request from the user terminal.

FIG. 6C is a drawing schematically illustrating an example of a user interface provided in response to the community channel searching request from the user terminal.

FIG. 7 is a drawing schematically illustrating an example user interface for supporting the user to create a new community channel in response to a new community channel creating request from the user terminal.

### DETAILED DESCRIPTION OF THE PREFERRED EMBODIMENTS

The following detailed description of the present disclosure refers to the accompanying drawings, which show by way of illustration a specific embodiment in which the present disclosure may be practiced, in order to clarify the objects, technical solutions and advantages of the present disclosure. These embodiments are described in sufficient detail to enable those skilled in the art to practice the present disclosure.

Besides, in the detailed description and claims of the present disclosure, a term “include” and its variations are not intended to exclude other technical features, additions, components, or steps. Other objects, benefits and features of the present disclosure will be revealed to one skilled in the art, partially from the specification and partially from the implementation of the present disclosure. The following examples and drawings will be provided as examples, but they are not intended to limit the present disclosure.

Moreover, the present disclosure covers all possible combinations of example embodiments indicated in this specification. It is to be understood that the various embodiments of the present disclosure, although different, are not necessarily mutually exclusive. For example, a particular feature, structure, or characteristic described herein in connection with one embodiment may be implemented within other embodiments without departing from the spirit and scope of the present disclosure. In addition, it is to be understood that the position or arrangement of individual elements within each disclosed embodiment may be modified without departing from the spirit and scope of the present disclosure. The following detailed description is, therefore, not to be taken in a limiting sense, and the scope of the present disclosure is defined only by the appended claims, appropriately interpreted, along with the full range of equivalents to which the claims are entitled. In the drawings, like numerals refer to the same or similar functionality throughout the several views.

To allow those skilled in the art to carry out the present disclosure easily, the example embodiments of the present disclosure will be explained by referring to attached diagrams in detail as shown below.

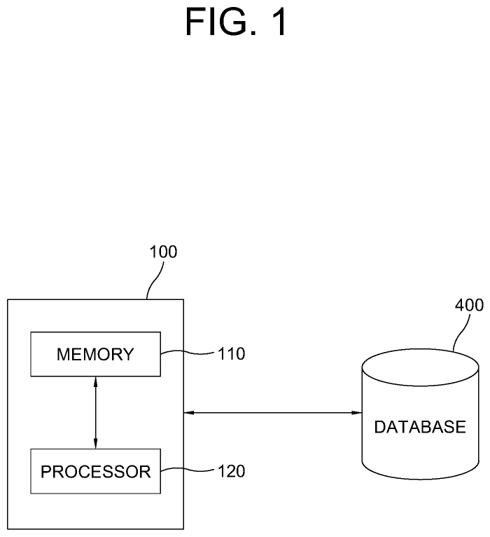

FIG. 1 is a drawing schematically illustrating a configuration of a community server which provides community services based on an electronic wallet.

By referring to FIG. 1, the community server 100 includes at least one memory 110 which stores at least one instruction for providing the community services based on a user electronic wallet and at least one processor 120 which provides the community services based on the user electronic wallet according to the instruction in the memory 110. Further, the community server 100 may include a personal computer, a mobile computer, etc.

Specifically, any combination of computing hardware and computing software may be configured as the community server 100 for achieving a required systematic performance for the present invention. The computing hardware may include at least one type of components among following types: a computing processor, a memory, a storage, an input device, an output device, and other components included by existing computing devices; and an electronic telecommunication device such as router and switch; and an electronic data storage system such as network-attached storage and storage area network. Also, the computing software may include the instruction which supports the community server 100 to function in a specific way.

Further, the processor 120 of the community server 100 may include following hardware components: a micro processing unit, i.e., MPU, a central processing unit, i.e., CPU, a cache memory, and a data bus. Further, the community server 100 also include following software components: at least one operation system and at least one application on specific purposes.

As another example, the community server 100 may include at least one medium processor and at least one integrated processor which is combined with at least one memory.

Also, the community server 100 may be interworked with at least one database 400 which stores information to be used for providing the community services based on the user electronic wallet. Herein, the database 400 may include at least one type of storage medium among following types: a flash memory type, a hard disk type, a multimedia card micro type, a card type memory (for instance, an SD memory or an XD memory), a random-access memory, i.e., RAM, a static random-access memory, i.e., SRAM, a read-only memory, i.e., ROM, an electrically erasable programmable read-only memory, i.e., EEPROM, a magnetic memory, a magnetic disk, an optical disk, but it is not limited thereto, such that the database also include all storage mediums capable of saving data. Also, the database 400 may be configured in a separate place from the community server 100. In contrary, the database 400 may also be configured inside the community server 100.

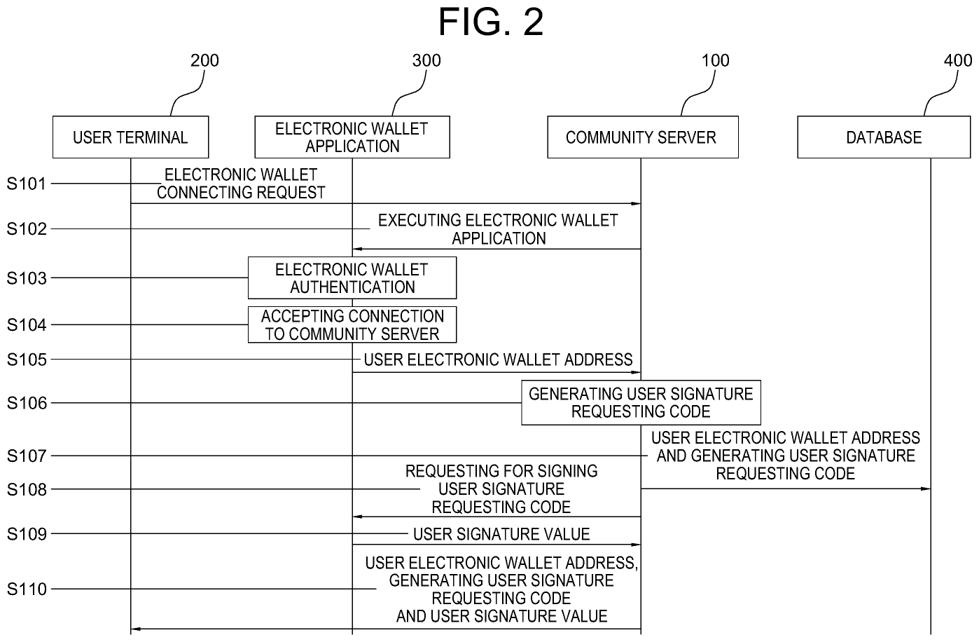

FIG. 2 is a drawing schematically illustrating a process of supporting a user to allow the community server to access a user electronic wallet application in response to an electronic wallet connecting request from a user terminal.

First, the user should connect his or her electronic wallet to the community server 100 to be provided with the community services.

Therefore, at a step of S101, a user terminal 200 may transmit an electronic wallet connecting request to the community server 100. That is, the user may request the community server 100 to connect the user electronic wallet through the user terminal 200.

Then, in response to acquiring the electronic wallet connecting request from the user terminal 200, the community server 100 supports an electronic wallet application 300 installed in the user terminal 200 to be executed at a step of S102.

As a result, at a step of S103, the electronic wallet application 300 supports the user to perform an authentication process. As one example, the electronic wallet application 300 may support the user to perform the authentication process using a PIN code, a biometric identification, a password, or the like which allows an access to the user electronic wallet. And then, the electronic wallet application 300 may support the user to select at least one user electronic wallet through which the community server 100 provides its corresponding one or more community services to the user.

In response to detecting that the user has selected the user electronic wallet for the community services, the electronic wallet application 300 may allow the user electronic wallet to be connected to the community server 100.

Next, in response to allowing the community server 100 to connect to the user electronic wallet at a step of S104, the electronic wallet application 300 may transmit an electronic wallet address corresponding to the user electronic wallet to the community server 100 at a step of S105.

As explained above, after the authentication process on the user electronic wallet is performed through the electronic wallet application 300, the user can select the user electronic wallet to be connected to the community server 100, but it is not limited thereto. As another example, the user may select the user electronic wallet to be connected to the community server 100 and then allow the authentication process on the user electronic wallet to be performed through the electronic wallet application 300.

As still another example, in case the electronic wallet application 300 has not been installed in the user terminal 200, the community server 100 may support the user to perform the authentication process on the user electronic wallet through a web service in response to acquiring the electronic wallet connecting request from the user terminal 200.

Next, if the user electronic wallet address is acquired, the community server 100 may generate a user signature requesting code at a step of S106.

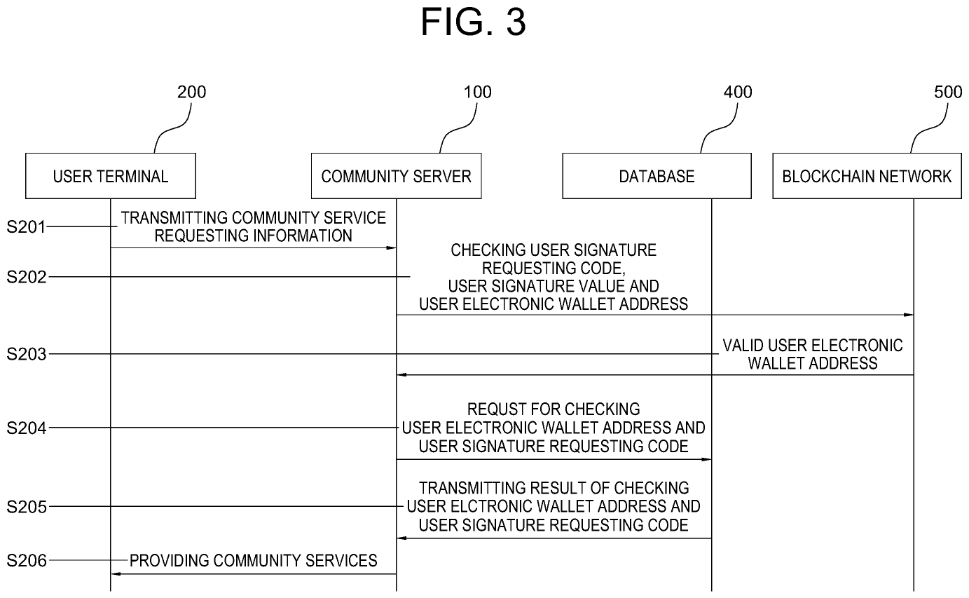

Then, the community server 100 may store the user electronic wallet address and the user signature requesting code in the database 400 corresponding to the community server 100 at a step of S107. Herein, the user electronic wallet address and the user signature requesting code stored in the database 400 may be used for verifying community service requesting information from the user terminal 200, which will be explained by referring to FIG. 3.

Thereafter, the community server 100 may transmit the user signature requesting code to the user electronic wallet application 300 installed in the user terminal 200, thereby requesting the user to sign the user signature requesting code at a step of S108.

Then, the user electronic wallet application 300 may generate a user signature value acquired by signing the user signature requesting code by a user private key and transmit the user signature value to the community server 100 at a step of S109.

Finally, the community server 100 may transmit the user electronic wallet address, the user signature requesting code, and the user signature value to the user terminal 200 at a step of S110. Herein, depending on the user's usage on the user electronic wallet, the community server 100 may also transmit a type of the user electronic wallet such as a web wallet, a mobile wallet, a desktop wallet, a staking wallet, etc., but it is not limited thereto. As another example, other types of the user electronic wallet may include blockchain network information where the user electronic wallet is issued, smart contract information related to the user electronic wallet or algorithm information used for generating the user electronic wallet.

As explained above, the community server 100 can transmit the user electronic wallet address, the user signature requesting code and the user signature value to the user terminal 200, but it is not limited thereto. As another example, the community server 100 may allow the user electronic wallet application 300 to transmit the user electronic wallet address, the user signature requesting code and the user signature value to the user terminal 200.

FIG. 3 is a drawing schematically illustrating a method of providing the community services based on the user electronic wallet in response to receiving community service requesting information from the user terminal.

First, on condition that the user electronic wallet address and the user signature requesting code have been registered in the database 400, the user terminal 200 may transmit the community service requesting information including the user electronic wallet address, the user signature requesting code and the user signature value to the community server 100 at a step of S201. Herein, the step of S201 represents an action of requesting an access to at least one of the community services by joining or logging on to the community services.

Accordingly, the community server 100 may request the blockchain network 500 to check whether the user electronic wallet address, the user signature requesting code and the user signature value are verified at a step of S202. And then, the blockchain network 500 may check whether the user electronic wallet address, the user signature requesting code and the user signature value are verified, and transmit a result of verification to the community server 100 at a step of S203.

As another example, the community server 100 may acquire a user public key from the blockchain network 500 and thus check whether the user signature requesting code, the user signature value and the user electronic wallet address are verified. As one example, the community server 100 may acquire the user public key corresponding to the user electronic wallet from the blockchain network 500 and decode the user signature value by using the user public key, thereby acquiring the user signature requesting code. Then, the community server 100 may check whether the user signature requesting code acquired by decoding the user signature value is coincident with the user signature requesting code received from the user terminal 200, thereby checking whether the user signature requesting code and the user signature value are verified. In addition, the community server 100 may check whether the user electronic wallet address is registered as a valid address on the blockchain network 500 by using the user public key.

Next, if the user electronic wallet address, the user signature requesting code, and the user signature value are verified, the community server 100 may check whether the user electronic wallet address and the user signature requesting code received from the user terminal 200 are coincident with the user electronic wallet address and the user signature requesting code stored in the database 400, thereby checking whether the user electronic wallet address and the user signature requesting code are valid at steps of S204 and S205.

Next, if the user electronic wallet address and the user signature requesting code are valid, the community server 100 determines that the user who requested at least one of the community services is a valid user and thus provides at least one of the community services to the user terminal 200.

That is, if the user electronic wallet address and the user signature requesting code are valid, the community server 100 may acquire 1-st current state information of the user electronic wallet by accessing the user electronic wallet using the user electronic wallet address. Next, the community server 100 may update previous accessible state information for each of community channels to 1-st current accessible state information for each of the community channels by referring to the 1-st current state information and each of access conditions for each of the community channels. As a result, the community server 100 may provide a user-specific community channel list including at least each of accessible user-specific community channels, among the community channels, which is determined by referring to the 1-st current accessible state information, to the user terminal 200, thereby allowing the user to be provided with at least one of the community services.

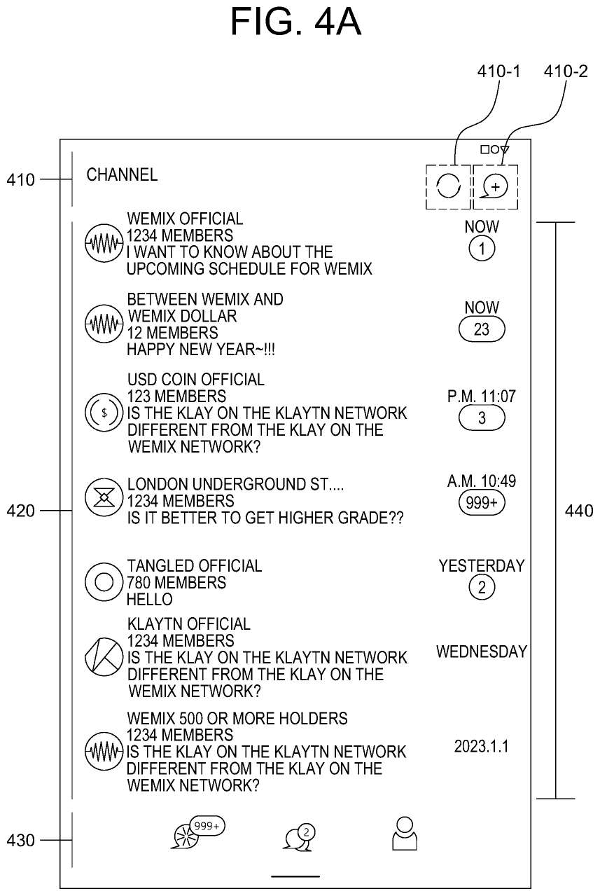

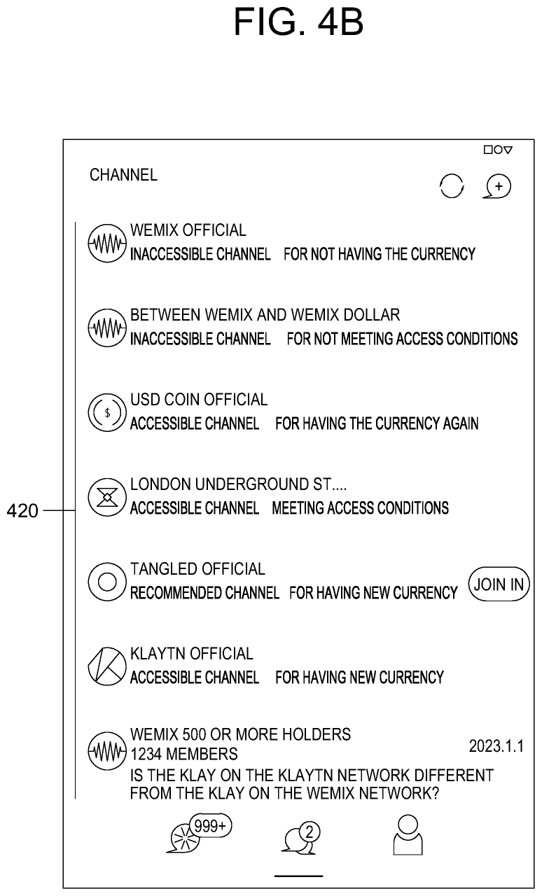

FIG. 4A and FIG. 4B are drawings schematically illustrating a user interface for providing information on the community services to the user through the user terminal.

As one example, by referring to FIG. 4A, the community server 100 may provide a user interface to the user terminal 200, thereby allowing the user to access at least one of the community services through the user interface displayed on the user terminal 200.

Herein, the user interface may include a synchronization menu 410-1, a searching menu 410-2, an application bar area 410 which provides menu buttons and function buttons, a community channel list area 420 which provides a user-specific community channel list, a global navigation bar area 430 which allows the user to easily access a main menu, and a scroll area 400 which allows the user to navigate the user-specific community channel list by scrolling the display, but it is not limited thereto.

Also, the 1-st current state information may include at least some part of information on kinds of one or more virtual currencies and balances of the virtual currencies stored in the user electronic wallet. That is, the community server 100 checks whether at least part of the kinds and the balances of the virtual currencies meets each of the access conditions for each of the community channels, thereby acquiring the 1-st current accessible state information. Further, the previous accessible state information for each of the community channels may represent each piece of accessible state information for each of the community channels determined by referring to information on the kinds of the virtual currencies and previous balances of the virtual currencies stored in the user electronic wallet before updating to the 1-st current state information, while the 1-st current accessible state information may represent each piece of accessible state information for each of the community channels determined by referring to the 1-st current state information of the virtual currencies stored in the user electronic wallet.

That is, the community server 100 may update the previous accessible state information for each of the community channels to the 1-st current accessible state information for each of the community channels by referring to the 1-st current state information and each of the access conditions for each of the community channels, and provide the user-specific community channel list including each of the accessible user-specific community channels, among the community channels, which is determined by referring to the 1-st current accessible state information, to the user terminal 200, thereby allowing the user to be provided with the community services. Herein, each of the access conditions for each of the community channels may include at least some part of information on the kinds of the virtual currencies and the balances of the virtual currencies stored in the user electronic wallet.

As one example, by referring to FIG. 4B, the community channel list area 420 may display the 1-st current accessible state information of the community channels which the user has joined. Herein, the 1-st current accessible state information is acquired by updating the previous accessible state information by referring to the 1-st current state information of the user electronic wallet.

Herein, the 1-st current accessible state information may indicate whether each of the community channels is accessible or not. In addition, the 1-st current accessible state information may further include at least one reason of not being able to access a certain inaccessible user-specific community channel, e.g., an absence of a certain virtual currency, a balance of the certain virtual currency lower than a certain access condition, etc. Further, the 1-st current accessible state information may further include at least one reason of being able to access the certain inaccessible user-specific community channel, e.g., re-gaining the certain virtual currency, a balance of the certain virtual currency same as or larger than the certain access condition, etc., but it is not limited thereto.

Meanwhile, in case the community server 100 provides the user-specific community channel list to the user terminal 200 which further includes each of inaccessible user-specific community channels to the user terminal 200, the community server 100 sorts each of the inaccessible community channels and each of the accessible community channels by referring to the 1-st current accessible state information and then displays each of the sorted inaccessible community channels through a first region of a screen of the user terminal 200 and each of the sorted accessible community channels through a second region of the screen of the user terminal 200. Herein, by referring to FIG. 4B, the first region is illustrated on an upper part of the screen of the user terminal 200 and the second region is illustrated on a middle part and a lower part of the screen of the user terminal 200, but it is not limited thereto.

Also, the community server 100 may further provide some recommended community channels in the user-specific community channel list by referring to the current state information of the user electronic wallet.

In addition, the community server 100 may synchronize the state information of the virtual currencies in the user electronic wallet every certain period of time. Herein the certain period of time may be either regular or irregular. That is, the community server 100 acquires 2-nd current state information every certain period of time by accessing the user electronic wallet using the user electronic wallet address. And then, the community server 100 updates the 1-st current accessible state information for each of the community channels to 2-nd current accessible state information for each of the community channels by referring to the 2-nd current state information and each of the access conditions for each of the community channels. As a result, the community server 100 may provide the user-specific community channel list on each of the accessible user-specific community channels, among the community channels, which is determined by referring to the 2-nd current accessible state information, to the user terminal 200.

Alternatively, the community server 100 may synchronize the state information of the virtual currencies in the user electronic wallet in response to a synchronization request from the user terminal 200. That is, by referring FIG. 4A again, in response to the synchronization request at a specific time from the user terminal 200, i.e., in response to detecting that the user selects the synchronization menu 410-1 to update the current state of the user electronic wallet, i.e. the kinds and the balances of the virtual currencies in the user electronic wallet, the user terminal 200 transmits the synchronization request to the community server 100 and then the community server 100 may acquire 3-rd current state information of the user electronic wallet by accessing the user electronic wallet using the user electronic wallet address. And then, the community server 100 updates the 1-st current accessible state information for each of the community channels to 3-rd current accessible state information for each of the community channels by referring to the 3-rd current state information and each of the access conditions for each of the community channels. As a result, the community server 100 provides the user-specific community channel list on each of the accessible user-specific community channels, among the community channels, which is determined by referring to the 3-rd current accessible state information, to the user terminal 200.

Meanwhile, by referring to FIG. 4A and FIG. 4B, the user may select a certain community channel, among the community channels in the user-specific channel list, to join the certain community channel.

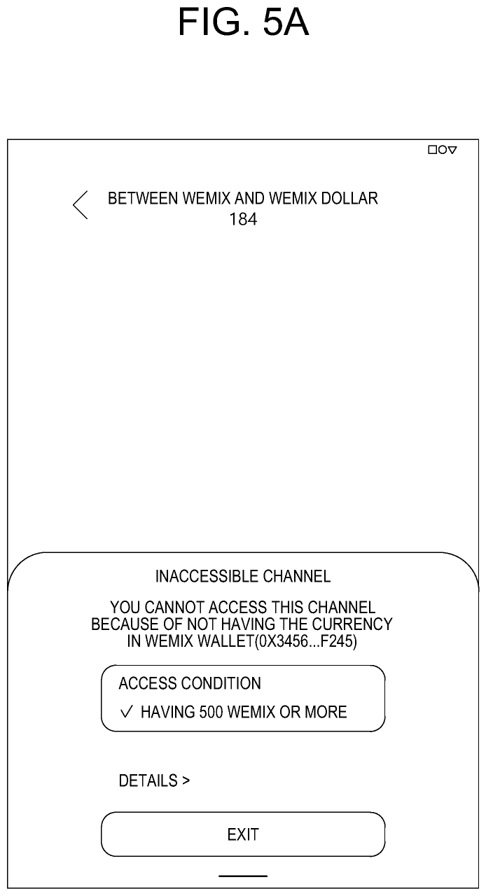

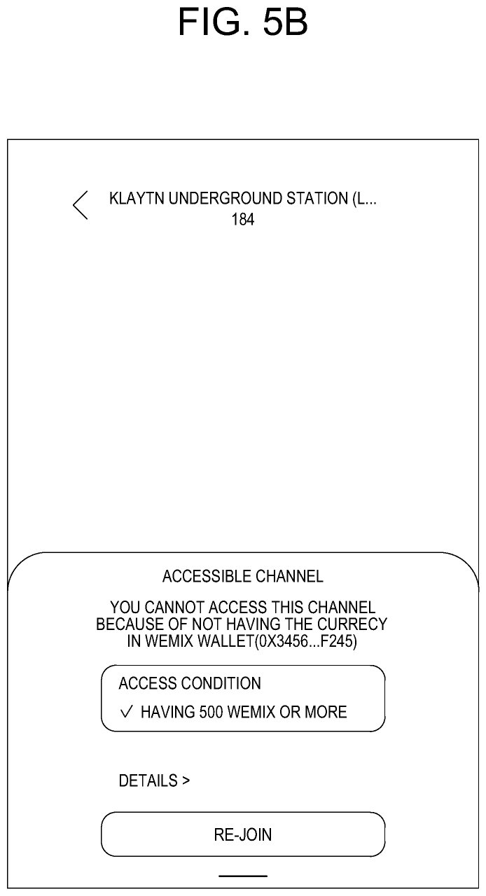

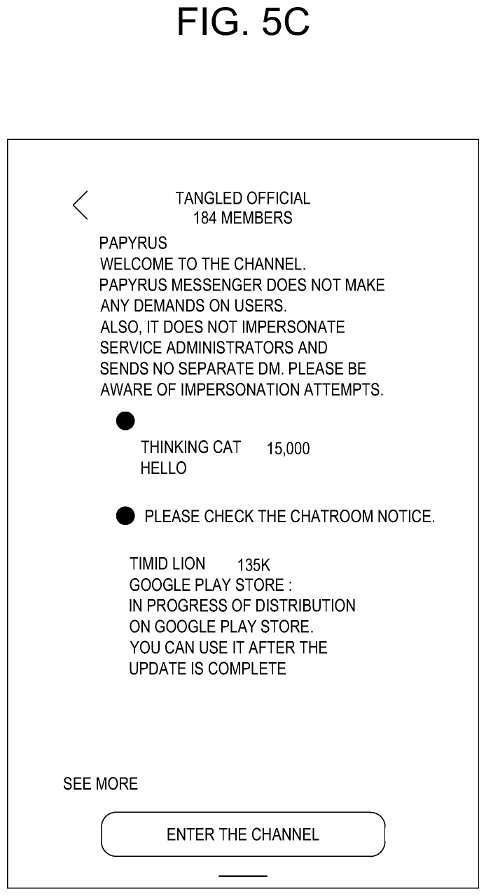

FIG. 5A is a drawing schematically illustrating a state of a screen provided as a result of selecting an inaccessible community channel among the community channels included in a user-specific community channel list.

As one example, by referring to FIG. 5A, in response to acquiring a community accessing request for a certain inaccessible user-specific community channel in the user-specific community channel list from the user terminal 200, the community server 100 may provide a certain user interface for the certain inaccessible user-specific community channel to the user terminal 200 while allowing information on at least one reason of not being able to access the certain inaccessible user-specific community channel to be displayed through the user terminal, without displaying information on messages shared among certain members belonging to the certain inaccessible user-specific community channel. Alternatively, in response to the community accessing request for the certain inaccessible user-specific community channel in the user-specific community channel list from the user terminal 200, the community server 100 may provide information on at least one reason of not being able to access the certain inaccessible user-specific community channel to the user terminal 200 using a popup menu without providing the certain channel interface for the certain inaccessible user-specific community channel to the user terminal 200.

FIG. 5B is a drawing schematically illustrating a state of the screen provided as a result of selecting an accessible community channel among the community channels included in the user-specific community channel list.

As another example, by referring to FIG. 5B, in response to acquiring a community accessing request for a certain accessible user-specific community channel in the user-specific community channel list from the user terminal 200, the community server 100 may provide a certain user interface for the certain accessible user-specific community channel to the user terminal 200 while allowing information on at least one reason of being able to access the certain accessible user-specific community channel to be displayed through the user terminal 200, without displaying information on messages shared among certain members belonging to the certain accessible user-specific community channel. And then, in response to detecting that the user selects re-joining the certain accessible user-specific community channel, the community server 100 may provide the certain community service through the certain user interface for the certain community channel. Alternatively, in response to the community accessing request for the certain accessible user-specific community channel in the user-specific community channel list from the user terminal 200, the community server 100 may provide information on at least one reason of being able to access the certain accessible user-specific community channel to the user terminal 200 using a popup menu without providing the certain channel interface for the certain accessible user-specific community channel to the user terminal 200.

FIG. 5C is a drawing schematically illustrating a state of the screen provided as a result of selecting a new accessible community channel among the community channels included in the user-specific community channel list. Herein, the new accessible community channel represents at least one community channel which was inaccessible but becomes accessible due to a change in an accessible condition thereof and/or a change in a state of the user electronic wallet.

As still another example, by referring to FIG. 5C, in response to acquiring the community accessing request for the new accessible user-specific community channel in the user-specific community channel list from the user terminal 200, the community server 100 may provide a new user interface for the new accessible user-specific community channel, thereby allowing the user to be provided with a new community service corresponding to the new accessible user-specific community channel.

Next, in response to acquiring a community channel searching request from the user terminal 200, the community server 100 may allow the user to select at least one certain virtual currency in the user electronic wallet. And then, in response to acquiring information on the selected certain virtual currency, the community server 100 may check whether each of the community channels is one of certain VC-related community channels corresponding to the certain virtual currency and then check certain accessible state information for each of the certain VC-related community channels by referring to each of certain access conditions for each of the certain VC-related community channels and certain virtual currency state information for the certain virtual currency. As a result, the community server 100 may provide a certain VC-related community channel list including the certain VC-related community channels each of which corresponds to the certain accessible state information to user terminal 200.

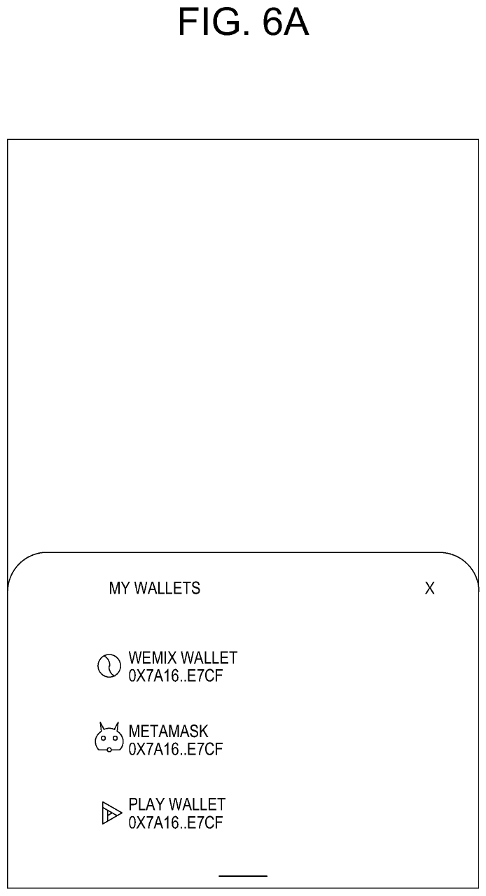

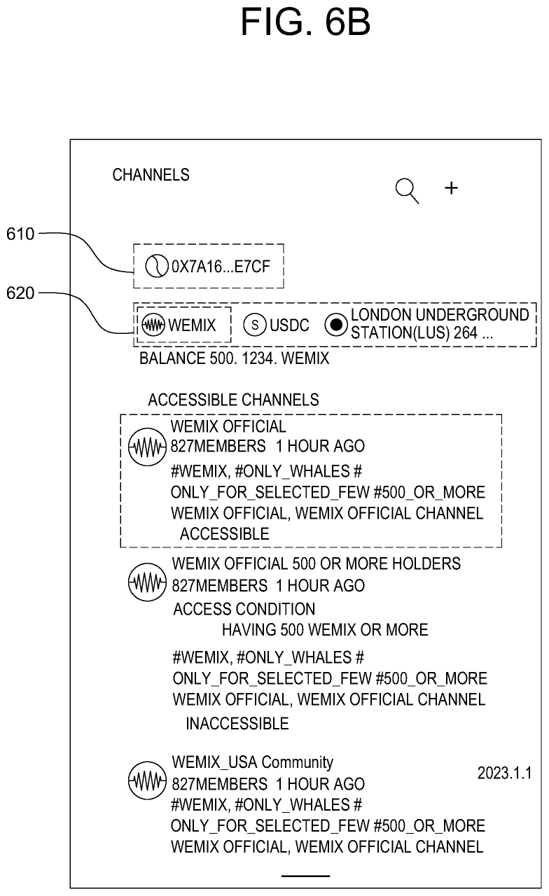

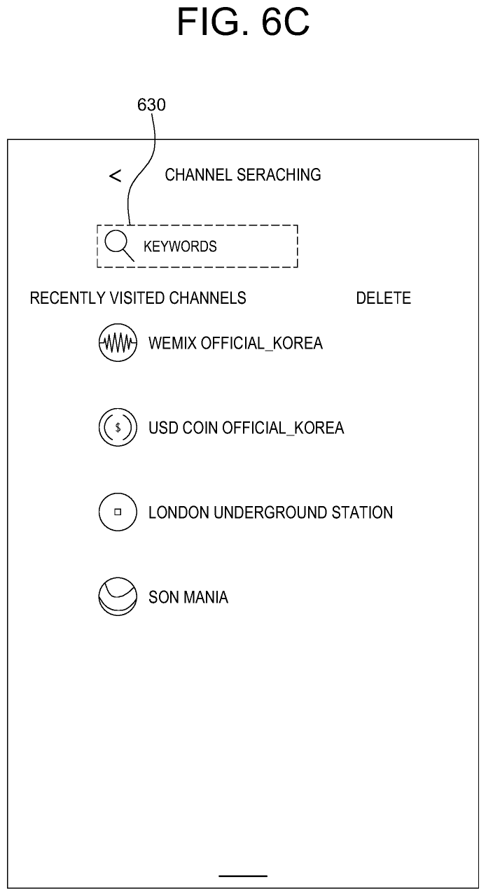

FIG. 6A is a drawing schematically illustrating an example of a list of user electronic wallets for allowing the user to select at least one of the user electronic wallets with which the user searches for one or more desired community channels.

As one example, by referring to FIG. 6A, in response to acquiring a community channel searching request from the user terminal 200, the community server 100 may provide the list of the user electronic wallets connected to the community server 100, thereby allowing the user to select a specific user wallet to be used for searching for the desired community channels.

FIG. 6B is a drawing schematically illustrating an example of some community channels retrieved as a result of the community channel searching request from the user terminal.

In response to detecting that the user has selected the specific user wallet to be used for searching for the desired community channels, by referring to FIG. 6B, the community server 100 may display current state information of the specific user electronic wallet 610. The current state information of the specific user electronic wallet 610 may include the list 620 of virtual currencies in the specific electronic wallet 610, and the user may select at least one certain virtual currency in the specific user electronic wallet 610. Further, in response to detecting that the user has selected WEMIX as the certain virtual currency, the community server 100 may check whether each of the community channels is one of the certain VC-related community channels, i.e., WEMIX-related community channels. And then the community server 100 may check certain accessible state information for each of the certain VC-related community channels by referring to each of certain access conditions for each of the certain VC-related community channels and certain virtual currency state information for the certain virtual currency. As a result, the community server 100 may provide the certain VC-related community channel list including the certain VC-related community channels each of which corresponds to the certain accessible state information to user terminal 200. Herein the information on the certain virtual currency may include at least part of the kind and the balance of the certain virtual currency, and the certain accessible state information for the certain VC-related community channels may include at least part of information on the accessibility of the user determined by the kind and the balance of the certain virtual currency. Also, the certain VC-related community channel list may include all the community channels corresponding to the certain virtual currency or a part of the community channels which the user can access.

As above, the user can search for his or her desired community channels by using the user electronic wallet, but it is not limited thereto. As another example, the user may search for the desired community channels without using the user electronic wallet as shown in FIG. 6C below.

FIG. 6C is a drawing schematically illustrating an example of a user interface provided in response to the community channel searching request from the user terminal.

As one example, by referring to FIG. 6C, if the community channel searching request is acquired from the user terminal 200 according to selection of a community channel searching menu by the user, the community server 100 may provide a community channel searching interface as a user interface to the user terminal 200, thereby supporting the user to input a kind or a keyword of the certain virtual currency in an input field 630. In addition, the community server 100 may provide a list further including past community channels which the user recently has visited. Further, in response to detecting that the user has inputted the kind of the keyword of the certain virtual currency, the community server 100 may retrieve desired community channels by using the kind or the keyword inputted from the user terminal 200.

In addition, in response to acquiring a new community channel creating request from the user terminal 200, the community server 100 may request the user to select at least one certain virtual currency stored in the user electronic wallet. And then, in response to acquiring information on the certain virtual currency from the user terminal 200, the community server 100 may request the user to set a new access condition for a new community channel. Finally, in response to acquiring information on the new access condition from the user terminal 200 to create the new community channel, the community server 100 may allow the new community channel to be exposed to search results.

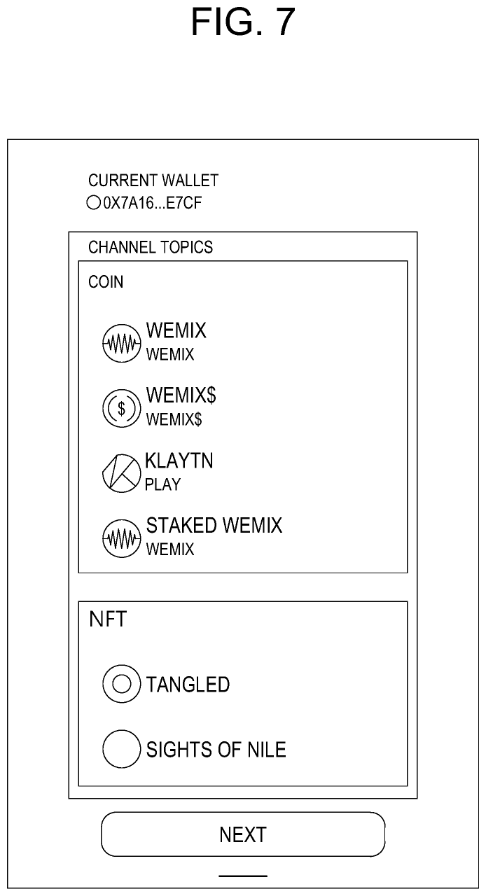

FIG. 7 is a drawing schematically illustrating an example user interface for supporting the user to create the new community channel in response to the new community channel creating request from the user terminal.

As one example, by referring to FIG. 7, in response to acquiring the new community channel creating request from the user terminal 200, the community server 100 may provide the list of the user electronic wallets connected to the community server 100, thereby allowing the user to select the specific user wallet to be used for searching for the desired community channels. Then, the community server 100 may display the list of the virtual currencies in the specific user electronic wallet to the user terminal 200, thereby allowing the user to select the certain virtual currency to be used for creating the new community channel. In response to acquiring information on the certain virtual currency from the user terminal 200, the community server 100 may request the user to set the new access condition for the new community channel. Herein, on condition that the user has selected two or more certain virtual currencies, the community server 100 may create the new community channel only if each of new access conditions corresponding to each of the certain virtual currencies is satisfied. Herein, the new community channel may be retrieved at the community channel searching request or provided as a list at the synchronization request from other user terminals.

The present invention has an effect of providing community services without exposing private information of the user.

The present invention has another effect of reducing a difficulty of the hosts of the community channels in checking whether each of the members meets each of the access conditions for each of the community channels.

The present invention has still another effect of reducing a difficulty of the user in checking whether the user oneself meets at least one of the access conditions without exposing the private information of the user.

The present invention has still yet another effect of allowing whether each of the members is matched with each of the access conditions for each of the community channels to be easily checked.

The present invention has still yet another effect of easily matching each of the members with each of topics corresponding to each of the community channels.

The suggested processes, which is in accordance with one example embodiment of the present disclosure, can be implemented in a programmed command which can be performed by various computer component, and can be written on a machine-readable medium or machine-decipherable medium. The machine-readable medium or machine-decipherable medium may include program commands, data files, data structures, or combination of aforementioned elements. The program commands written on the machine-readable medium or machine-decipherable medium may be specifically designed or complied only to perform aforementioned processes or may be allowed to use after notices to those skilled in the art of present disclosure. The machine-readable medium or machine-decipherable medium can be one of follow media: a hard disk, a magnetic medium such as a floppy disk or a magnetic tape, an optical medium such as CD-ROM and DVD, a magnetooptical medium such as a floptical disk, a ROM, a RAM, a Flash memory, and other hardware components which are designed to save and perform the program commands. The program commands may be written in one of complied languages or one of interpreted languages. The hardware device may be configured to perform the process of this disclosure as at least one or more software module, and vice versa.

As seen above, the present disclosure has been explained by specific matters such as detailed components, limited embodiments, and drawings. While the invention has been shown and described with respect to the preferred embodiments, it, however, will be understood by those skilled in the art that various changes and modification may be made without departing from the spirit and scope of the invention as defined in the following claims.

Accordingly, the thought of the present disclosure must not be confined to the explained embodiments, and the following patent claims as well as everything including variations equal or equivalent to the patent claims pertain to the category of the thought of the present disclosure.

1. A method for providing a community service to a user based on a user electronic wallet, comprising steps of:
(a) on condition that a user electronic wallet address which is acquired from a user electronic wallet application and a user signature requesting code which is provided to a user terminal have been registered in a database, in response to acquiring community service requesting information including the user electronic wallet address, the user signature requesting code and a user signature value from the user terminal, wherein the user signature value is acquired by signing the user signature requesting code with a user private key, a community server acquiring a user public key and checking whether the user signature requesting code, the user signature value and the user electronic wallet address are verified; and
(b) in response to detecting that the user electronic wallet address, the user signature requesting code, and the user signature value received from the user terminal are verified, the community server checking whether the user electronic wallet address and the user signature requesting code are valid by using the database, and in response to detecting that the user electronic wallet address and the user signature requesting code are valid, the community server (i) acquiring 1-st current state information of the user electronic wallet by accessing the user electronic wallet using the user electronic wallet address, (ii) updating previous accessible state information for each of community channels to 1-st current accessible state information for each of the community channels by referring to the 1-st current state information and each of access conditions for each of the community channels and (iii) providing a user-specific community channel list including each of accessible user-specific community channels, among the community channels, which is determined by referring to the 1-st current accessible state information, to the user terminal.

2. The method of claim 1, before the step (a), further comprising steps of:
(a01) in response to acquiring an electronic wallet connecting request from the user terminal, the community server supporting the user to allow the community server to access the user electronic wallet application; and
(a02) in response to acquiring the user electronic wallet address from the user electronic wallet application after receiving a permission to access the user electronic wallet application from the user, the community server generating the user signature requesting code corresponding to the user electronic wallet address, storing the user signature requesting code and the user electronic wallet address in the database, and acquiring the user signature value from the user electronic wallet application; and
(a03) the community server transmitting the user electronic wallet address, the user signature requesting code, and the user signature value to the user terminal or allowing the user electronic wallet application to transmit the user electronic wallet address, the user signature requesting code, and the user signature value to the user terminal.

3. The method of claim 1, further comprising a step of:
(c) the community server, (i) acquiring 2-nd current state information every certain period of time by accessing the user electronic wallet using the user electronic wallet address, updating the 1-st current accessible state information for each of the community channels to 2-nd current accessible state information for each of the community channels by referring to the 2-nd current state information and each of the access conditions for each of the community channels, and providing the user-specific community channel list on each of the accessible user-specific community channels, among the community channels, which is determined by referring to the 2-nd current accessible state information, to the user terminal, or (ii) acquiring 3-rd current state information of the user electronic wallet by accessing the user electronic wallet using the user electronic wallet address in response to a synchronization request at a specific time from the user terminal, updating the 1-st current accessible state information for each of the community channels to 3-rd current accessible state information by referring to the 3-rd current state information and each of the access conditions for each of the community channels, and providing the user-specific community channel list on each of the accessible user-specific community channels, among the community channels, which is determined by referring to the 3-rd current accessible state information, to the user terminal.

4. The method of claim 1, wherein, in response to acquiring at least some part of information on kinds of one or more virtual currencies and balances of the virtual currencies stored in the user electronic wallet as the 1-st current state information of the user electronic wallet, the community server checks whether at least part of the kinds and the balances of the virtual currencies meets each of the access conditions for each of the community channels, thereby acquiring the 1-st current accessible state information.

5. The method of claim 1, wherein, in case the community server provides the user-specific community channel list which further includes each of inaccessible user-specific community channels to the user terminal, the community server sorts each of the inaccessible community channels and each of the accessible community channels by referring to the 1-st current accessible state information and then displays each of the sorted inaccessible community channels through a first region of a screen of the user terminal and each of the sorted accessible community channels through a second region of the screen of the user terminal.

6. The method of claim 1, further comprising a step of:
(d) in response to acquiring a community accessing request for a certain inaccessible user-specific community channel in the user-specific community channel list from the user terminal, the community server providing at least one reason of not being able to access the certain inaccessible user-specific community channel to the user terminal by referring to a certain access condition of the certain inaccessible user-specific community channel and the 1-st current state information.

7. The method of claim 1, further comprising a step of:
(e) (i) in response to acquiring a community channel searching request from the user terminal, the community server allowing the user to select at least one certain virtual currency in the user electronic wallet, and (ii) in response to acquiring information on the selected certain virtual currency, the community server checking whether each of the community channels is one of certain VC-related community channels corresponding to the certain virtual currency and then checking certain accessible state information for each of the certain VC-related community channels by referring to each of certain access conditions for each of the certain VC-related community channels and certain virtual currency state information for the certain virtual currency, and (iii) the community server providing a certain VC-related community channel list including the certain VC-related community channels each of which corresponds to the certain accessible state information to the user terminal.

8. The method of claim 1, further comprising a step of:
(f) (i) in response to acquiring a new community channel creating request from the user terminal, the community server requesting the user to select at least one certain virtual currency stored in the user electronic wallet, (ii) in response to acquiring information on the certain virtual currency from the user terminal, the community server requesting the user terminal to set a new access condition for a new community channel, and (iii) in response to acquiring information on the new access condition from the user terminal to create the new community channel, the community server allowing the new community channel to be exposed to search results.

9. The method of claim 1, wherein, at the step (a), the community server requests the blockchain network to verify the user electronic wallet address, the user signature requesting code, and the user signature value received from the user terminal.

10. The method of claim 1, wherein, at the step (a), the community server (i) decodes the user signature value received from the user terminal by using the user public key and thus acquires the user signature requesting code, (ii) checks whether the user signature requesting code acquired by decoding the user signature value is coincident with the user signature requesting code received from the user terminal and thus checks whether the user signature requesting code and the user signature value received from the user terminal are verified, and (iii) checks whether the user electronic wallet address acquired from the user terminal is registered as a valid address in the blockchain network and thus verifies whether the user electronic wallet address acquired from the user terminal is valid; and
wherein, at the step (b), the community server checks whether the user electronic wallet address and the user signature requesting code received from the user terminal are coincident with the user electronic wallet address and the user signature requesting code stored in the database and thus verifies whether the user electronic wallet address and the user signature requesting code received from the user terminal are valid.

11. A community server for providing a community service to a user based on a user electronic wallet, comprising:
at least one memory which stores instructions; and
at least one processor configured to execute the instructions to perform or support another device to perform processes of: (I) on condition that a user electronic wallet address which is acquired from a user electronic wallet application and a user signature requesting code which is provided to a user terminal have been registered in a database, in response to acquiring community service requesting information including the user electronic wallet address, the user signature requesting code and a user signature value from the user terminal, wherein the user signature value is acquired by signing the user signature requesting code with a user private key, acquiring a user public key and checking whether the user signature requesting code, the user signature value and the user electronic wallet address are verified; and (II) in response to detecting that the user electronic wallet address, the user signature requesting code, and the user signature value received from the user terminal are verified, checking whether the user electronic wallet address and the user signature requesting code are valid by using the database, and in response to detecting that the user electronic wallet address and the user signature requesting code are valid, (i) acquiring 1-st current state information of the user electronic wallet by accessing the user electronic wallet using the user electronic wallet address, (ii) updating previous accessible state information for each of community channels to 1-st current accessible state information for each of the community channels by referring to the 1-st current state information and each of access conditions for each of the community channels and (iii) providing a user-specific community channel list including each of accessible user-specific community channels, among the community channels, which is determined by referring to the 1-st current accessible state information, to the user terminal.

12. The community server of claim 11, wherein, before the process (I), the processor further performs processes of:
(I_01) in response to acquiring an electronic wallet connecting request from the user terminal, supporting the user to allow the community server to access the user electronic wallet application; and
(I_02) in response to acquiring the user electronic wallet address from the user electronic wallet application after receiving a permission to access the user electronic wallet application from the user, generating the user signature requesting code corresponding to the user electronic wallet address, storing the user signature requesting code and the user electronic wallet address in the database, and acquiring the user signature value from the user electronic wallet application; and
(I_03) transmitting the user electronic wallet address, the user signature requesting code, and the user signature value to the user terminal or allowing the user electronic wallet application to transmit the user electronic wallet address, the user signature requesting code, and the user signature value to the user terminal.

13. The community server of claim 11, wherein the processor further performs a process of:
(III) (i) acquiring 2-nd current state information every certain period of time by accessing the user electronic wallet using the user electronic wallet address, updating the 1-st current accessible state information for each of the community channels to 2-nd current accessible state information for each of the community channels by referring to the 2-nd current state information and each of the access conditions for each of the community channels, and providing the user-specific community channel list on each of the accessible user-specific community channels, among the community channels, which is determined by referring to the 2-nd current accessible state information, to the user terminal, or (ii) acquiring 3-rd current state information of the user electronic wallet by accessing the user electronic wallet using the user electronic wallet address in response to a synchronization request at a specific time from the user terminal, updating the 1-st current accessible state information for each of the community channels to 3-rd current accessible state information by referring to the 3-rd current state information and each of the access conditions for each of the community channels, and providing the user-specific community channel list on each of the accessible user-specific community channels, among the community channels, which is determined by referring to the 3-rd current accessible state information, to the user terminal.

14. The community server of claim 11, wherein, in response to acquiring at least some part of information on kinds of one or more virtual currencies and balances of the virtual currencies stored in the user electronic wallet as the 1-st current state information of the user electronic wallet, the processor checks whether at least part of the kinds and the balances of the virtual currencies meets each of the access conditions for each of the community channels, thereby acquiring the 1-st current accessible state information.

15. The community server of claim 11, wherein, in case the community server provides the user-specific community channel list which further includes each of inaccessible user-specific community channels to the user terminal, the processor sorts each of the inaccessible community channels and each of the accessible community channels by referring to the 1-st current accessible state information and then displays each of the sorted inaccessible community channels through a first region of a screen of the user terminal and each of the sorted accessible community channels through a second region of the screen of the user terminal.

16. The community server of claim 11, wherein the processor further performs a process of:
(IV) in response to acquiring a community accessing request for a certain inaccessible user-specific community channel in the user-specific community channel list from the user terminal, providing at least one reason of not being able to access the certain inaccessible user-specific community channel to the user terminal by referring to a certain access condition of the certain inaccessible user-specific community channel and the 1-st current state information.

17. The community server of claim 11, wherein the processor further performs a process of:
(V) (i) in response to acquiring a community channel searching request from the user terminal, allowing the user to select at least one certain virtual currency in the user electronic wallet, and (ii) in response to acquiring information on the selected certain virtual currency, checking whether each of the community channels is one of certain VC-related community channels corresponding to the certain virtual currency and then checking certain accessible state information for each of the certain VC-related community channels by referring to each of certain access conditions for each of the certain VC-related community channels and certain virtual currency state information for the certain virtual currency, and (iii) providing a certain VC-related community channel list including the certain VC-related community channels each of which corresponds to the certain accessible state information to user terminal.

18. The community server of claim 11, wherein the processor further performs a process of:
(VI) (i) in response to acquiring a new community channel creating request from the user terminal, requesting the user to select at least one certain virtual currency stored in the user electronic wallet, (ii) in response to acquiring information on the certain virtual currency from the user terminal, requesting the user terminal to set a new access condition for a new community channel, and (iii) in response to acquiring information on the new access condition from the user terminal to create the new community channel, allowing the new community channel to be exposed to search results.

19. The community server of claim 1, wherein, at the process (I), the processor requests the blockchain network to verify the user electronic wallet address, the user signature requesting code, and the user signature value received from the user terminal.

20. The community server of claim 11, wherein, at the process (I), the processor (i) decodes the user signature value received from the user terminal by using the user public key and thus acquires the user signature requesting code, (ii) checks whether the user signature requesting code acquired by decoding the user signature value is coincident with the user signature requesting code received from the user terminal and thus checks whether the user signature requesting code and the user signature value received from the user terminal are verified, and (iii) checks whether the user electronic wallet address acquired from the user terminal is registered as a valid address in the blockchain network and thus verifies whether the user electronic wallet address acquired from the user terminal is valid; and
wherein, at the process (II), the processor checks whether the user electronic wallet address and the user signature requesting code received from the user terminal are coincident with the user electronic wallet address and the user signature requesting code stored in the database and thus verifies whether the user electronic wallet address and the user signature requesting code received from the user terminal are valid.
